(19) United States
(12) Patent Application Publication
(10) Pub. No.: US 2025/0371847 A1
(43) Pub. Date: Dec. 4, 2025

(54) SYSTEMS AND METHODS OF DATA DRIVEN OBJECT DETECTION FRAMEWORK FOR BOREHOLE IMAGE ANALYSIS

(71) Applicant: Schlumberger Technology Corporation, Sugar Land, TX (US)

(72) Inventors: Josselin Kherroubi, Clamart (FR); Ahmed Ben Saad, Paris (FR); Grabriele Facciolo, Cachan (FR)

(21) Appl. No.: 18/679,498

(22) Filed: May 31, 2024

(51) Int. Cl. G06V 10/774; G06T 11/00

(52) U.S. Cl. CPC G06V 10/774; G06T 11/00

(57) ABSTRACT

A system is provided that includes a processing circuitry and a memory, accessible by the processing circuitry, the memory storing instructions that, when executed by the processing circuitry cause the processing circuitry to perform operations. The operations may include generating synthetic dataset representative of a plurality of synthetic borehole images and training a feature detection based on the synthetic dataset, wherein the feature detection model predicts one or more features associated with a plurality of borehole images at one or more depths, one or more parameters associated with the one or more features, or both. The operations may also include generating a prediction dataset comprising a predicted detection vector and a predicted parameter matrix based on the feature detection model.

### BACKGROUND

The present disclosure generally relates to systems and methods for analyzing borehole images, and more specifically to applying deep learning to feature selection during borehole image analysis.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Wells drilled through geological formations may pass through numerous sedimentary layers (e.g., strata of different types of rock). Interfaces between different sedimentary layers of geological formations may be referred to as bed boundaries. Interfaces along sedimentary layers may also include faults and/or fractures that may occur natural and/or may be induced by the drilling process. Borehole imaging may be used to characterize geological formations by identifying bed boundaries, sedimentary layers, faults, fractures, and the like. For example, borehole images may be used to identify the placement of the bed boundaries in geological formations to help locate zones of interest, such as those that contain oil, gas, and/or water.

When imaging boreholes, geological planar surfaces (bed boundaries, fractures, faults, etc.) appear in the image as features. Features may include sinusoids (e.g., “dips”), parabolas (e.g., closed dips), and the like. A feature is defined relative to a predetermined system of coordinates associated to a tool (e.g., downhole tool) by two angles (e.g., apparent dip angle or apparent inclination relative to the axis of the borehole and apparent azimuth angle relative to a north axis projected on a tool section) and by a measured depth (e.g., curvilinear length of the borehole). The feature may also be converted in a “true” coordinate system (e.g., zenith, east, north) and in “true” depth using measurements performed in or near the borehole. In the following, the feature may be expressed in the apparent coordinates system (i.e. associated to the tool) and “feature angle”, “inclination” or “azimuth angle” refers to “apparent feature angle”, “apparent inclination” or “apparent azimuth angle”.

The apparent formation feature (e.g., apparent formation dip), may be particularly useful both for drilling into the stratum of the formation where the zone of interest is located, as well as for locating the placement of the bed boundaries throughout the geological formation. Although there may be a variety of downhole tools that can image the wellbore, systematically identifying features (e.g., formation dips, closed dips) from a borehole image in an accurate and time-efficient manner may prove to be a challenge.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a system is provided that includes a processing circuitry and a memory, accessible by the processing circuitry, the memory storing instructions that, when executed by the processing circuitry cause the processing circuitry to perform operations. The operations may include generating synthetic dataset representative of a plurality of synthetic borehole images and training a feature detection based on the synthetic dataset, wherein the feature detection model predicts one or more features associated with a plurality of borehole images at one or more depths, one or more parameters associated with the one or more features, or both. The operations may also include generating a prediction dataset including a predicted detection vector and a predicted parameter matrix based on the feature detection model, wherein the predicted detection vector includes one or more indications of the one or more features at the one or more depths, and wherein the predicted parameter matrices include the one or more parameters associated with the one or more features.

In certain embodiments, a method includes generating synthetic dataset representative of a plurality of synthetic borehole images and training a feature detection model based on the synthetic dataset, wherein the feature detection model is configured to predict one or more features associated with a plurality of borehole images at one or more depths, one or more parameters associated with the one or more features, or both. The method may also include generating a prediction dataset including a predicted detection vector and a predicted parameter matrix based on the feature detection model, wherein the predicted detection vector includes one or more indications of the one or more features at the one or more depths, and wherein the predicted parameter matrix includes the one or more parameters associated with the one or more features.

In certain embodiments, a non-transitory, computer-readable storage medium, comprising processor-executable routines that, when executed by a processor, cause the processor to perform operations includes generating synthetic dataset representative of a plurality of synthetic borehole images and training a feature detection model based on the synthetic dataset, wherein the feature detection model predicts one or more features associated with a plurality of borehole images at one or more depths, one or more parameters associated with the one or more features, or both. The operations may also include generating a prediction dataset comprising a predicted detection vector and a predicted parameter matrix based on the feature detection model, wherein the predicted detection vector includes one or more indications of the one or more features at the one or more depths, and wherein the predicted parameter matrices include the one or more parameters associated with the one or more features.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram illustrating an example well-logging system that may obtain borehole images at variable depths of a formation, in accordance with an embodiment of the present disclosure;

FIG. 2 is an example image of a borehole image, in accordance with an embodiment of the present disclosure;

FIG. 3 is a schematic embodiment of a framework of a feature detection model system, in accordance with aspects of the present disclosure;

FIG. 4 is a flow chart of a process for generating a synthetic dataset, in accordance with an embodiment of the present disclosure;

FIG. 5 is a schematic embodiment illustrating a simulated cylinder borehole image transformed into a sinusoid upon “unwrapping”, in accordance with an embodiment of the present disclosure;

FIG. 6 is a schematic embodiment a protocol for generating synthetic data for use in training the feature detection model, in accordance with an embodiment of the present disclosure;

FIG. 7 is a flow chart of a process for training a feature detection model system to output a prediction dataset, in accordance with an embodiment of the present disclosure;

FIG. 8 is a flow chart of a process for generating a loss function to generate confidence probabilities associated with the prediction dataset of the feature detection model, in accordance with an embodiment of the present disclosure;

FIG. 9 is a flow chart of a process for applying one or more post processing steps to the prediction dataset, in accordance with an embodiment of the present disclosure;

FIG. 10 is a flow chart of a process for validating the feature detection model, in accordance with an embodiment of the present disclosure;

FIG. 11 is a schematic embodiment illustrating comparison of a predicted feature represented by a normal vector and a ground truth value represented by a ground truth vector, in accordance with an embodiment of the present disclosure; and

FIG. 12 is a schematic embodiment of features associated with borehole images obtained via the well-logging tool of FIG. 1 including a sinusoid and a closed dip, in accordance with an embodiment of the present disclosure.

### DETAILED DESCRIPTION

Certain embodiments commensurate in scope with the present disclosure are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

As used herein, the term “coupled” or “coupled to” may indicate establishing either a direct or indirect connection (e.g., where the connection may not include or include intermediate or intervening components between those coupled), and is not limited to either unless expressly referenced as such. The term “set” may refer to one or more items. Wherever possible, like or identical reference numerals are used in the figures to identify common or the same elements. The figures are not necessarily to scale and certain features and certain views of the figures may be shown exaggerated in scale for purposes of clarification.

As used herein, the terms “inner” and “outer”; “up” and “down”; “upper” and “lower”; “upward” and “downward”; “above” and “below”; “inward” and “outward”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.

Furthermore, when introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment,” “an embodiment,” or “some embodiments” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase A “or” B is intended to mean A, B, or both A and B.

As used herein, the term “processing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM).

Borehole imaging may be used to detect and interpret geological events and features. For example, borehole imaging may be used to evaluate borehole stability by detecting fractures both natural and induced by drilling processes. Further, borehole imaging may be used to characterize geological formations intersected by the borehole to detect sedimentary layers and features. Various physical measurements (e.g., resistivity, ultrasonic, gamma-ray measures) may yield a borehole image. Detection and parametrization of borehole dips (e.g., sinusoids) from the borehole image may provide information related to orientation of features, depths of features, structural data associated with the borehole, and the like. Traditional approaches to borehole image analysis may rely on manual dip picking. Manual dip picking may be a time-consuming process that yields inconsistent results based on the experts' interpretations for dip selection. As a result, manual dip picking may result in enterprise's inefficiencies and/or user bias of feature selection. Further, certain methods for automatic selection of dip picking may identify a portion of features but may not provide consistent identification due to variance of borehole characteristics (e.g., sinusoids, distorted sinusoids, closed dips). Further, current automatic dip picking processes may lack consistent extraction of characterization of the identified features for further parameterization. As such, there is a need for systematic detection of features in borehole images and consistent characterization of parameters associated with the identified features.

Accordingly, the present disclosure techniques may be used to improve techniques for identifying and analyzing one or more features (e.g., dips, sinusoids, closed dips) captured in borehole images. The features may be used in detection and interpretation of structural characteristics within geological formations. As such, embodiments of the present disclosure relate to generation of a feature detection model. The feature detection model may be generated through implementation of artificial intelligence (AI) driven training and testing. In some embodiments, the feature detection model (e.g., AI model) may be trained with a synthetic dataset, which may represent expected datasets for analysis. The synthetic dataset may be used to train the feature detection model to provide scalable, adjustable, and/or flexible inputs. Additionally and/or alternatively, training with synthetic data may reduce a number of real datasets used to prepare the feature detection model to predict features. The synthetic dataset may be generated through generation of a content dataset generated using general parameters associated with borehole features. The general parameters may include a depth, a phase, an amplitude, and the like associated with a feature. Further, one or more style transformations (e.g., associated with texture characteristics of a borehole image, a borehole, a well-logging system, and the like) may be applied to the content dataset to generate the synthetic dataset. The synthetic dataset and/or a real dataset (e.g., data extracted from real-world borehole images) may then be used to train the feature detection model. After training, the feature detection model may be used to perform image analysis on borehole images to generate predictions and identify parameters associated with features present in geological formations. In this manner, implementation of the feature detection model enables streamlining of feature selection within borehole image analysis.

In some embodiments, the feature detection model may be iteratively updated based on optimization of generated prediction confidences. A loss function may be generated to evaluate the detection and regression of the feature detection model. Based on the resulting loss function, the feature detection model may be updated to increase confidence probabilities of predictions by updating the training process. Further, in some embodiments, a processing system may perform post processing of the predictions of the feature detection model to filter predictions within a sensitivity value (e.g., a predetermined corresponding depth). Filtering of predictions within the sensitivity value may reduce multiple identifications of a single or the same feature. Post-processing may may select the prediction associated with a greatest prediction confidence and remove additional and/or alternative predictions within the sensitivity value from a prediction dataset.

In certain embodiments, the feature detection model may be evaluated based on comparison to ground truth values. As such, feature predictions may be categorized based on detection of features and/or parameters associated with the detected features. In some instances, the parameters may include depths, phases, and/or amplitudes of feature predictions. A precision of the feature detection model may be determined based on the categorization of predictions for comparison to alternative techniques. In this manner, the feature detection model may be compared to alternative dip picking methods such as manual dip picking, automatic dip picking, and the like.

Further, in some embodiments, the feature detection model may be generalized to detect complex features that may be found in geological formations. For example, non-planar structures found in borehole images may provide information relating to bed boundaries of the geological formation. That is, closed dips may provide insight of a structure of the geological formations though they do not form a sinusoid (e.g., traditionally formed by dips) in flat images extracted from borehole images. As described herein, generalization of the feature detection model may be used to identify complex features and provide predictions relating to intersections of three-dimensional shapes within boreholes. These features may be provided in seismic data images, which may be used to identify hydrocarbon deposits, map geological formations, and the like to expedite and improve hydrocarbon exploration and production operations.

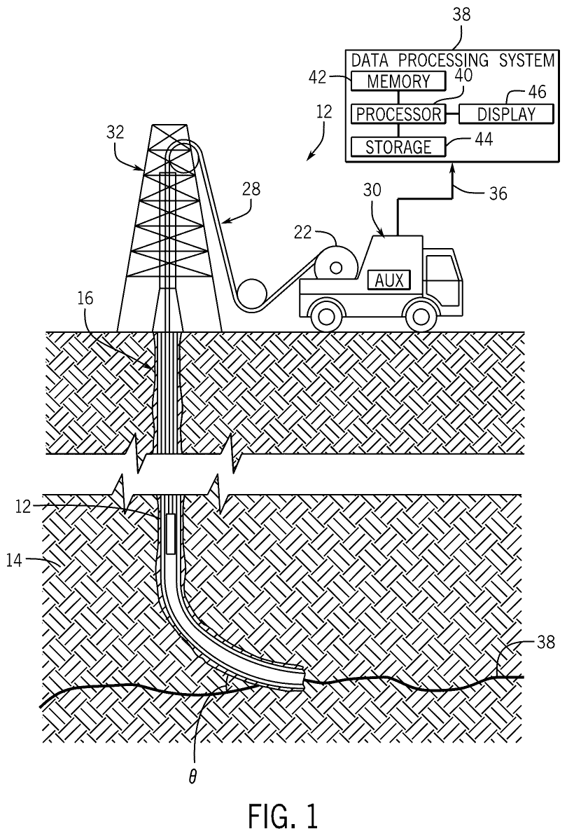

With this in mind, FIG. 1 is a schematic diagram illustrating an example well-logging system 10 that may obtain borehole images at variable depths of a formation, in accordance with an embodiment. The well-logging system 10 may be conveyed through a geological formation 14 via a wellbore 16. A downhole tool 12 may be conveyed on a cable 18 via a logging winch system 20. Although the logging winch system 20 is schematically shown in FIG. 1 as a mobile logging winch system carried by a truck, the logging winch system 20 may be substantially fixed (e.g., a long-term installation that is substantially permanent or modular). Any suitable cable 18 for well logging may be used. The cable 18 may be spooled and unspooled on a drum 22 and an auxiliary power source 24 may provide energy to the logging winch system 20 and/or the downhole tool 12. With the preceding in mind, FIG. 1 relate to a generalized system or configurations that may be employed to provide borehole images to a processing system which the present approaches may be employed.

Although the downhole tool 12 is described as a wireline downhole tool, it should be appreciated that any suitable conveyance may be used. For example, the downhole tool 12 may instead be conveyed as a logging-while-drilling (LWD) tool as part of a bottom hole assembly (BHA) of a drill string, conveyed on a slickline or via coiled tubing, and so forth. For the purposes of this disclosure, the downhole tool 12 may be any suitable measurement tool that obtains multidimensional measurements through depths of the wellbore 16.

Many types of downhole tools may obtain measurements in the wellbore 16. For each depth of the wellbore 16 that is measured, the downhole tool 12 may generate log data (e.g., a borehole image, density, and/or photoelectric factor measurements). The downhole tool 12 may provide such measurements 26 to a data processing system 28 via any suitable telemetry (e.g., via electrical signals pulsed through the geological formation 14 or via mud pulse telemetry). The data processing system 28 may process the measurements 26 to identify patterns related to properties of the geological formation 14 or the wellbore 16. The patterns in the measurements 26 may indicate certain properties of the wellbore 16 (e.g., formation dip) that could be otherwise indiscernible by a human operator.

To this end, the data processing system 28 thus may be any electronic data processing system that can be used to carry out the systems and methods of this disclosure. For example, the data processing system 28 may include a processor 30, which may execute instructions stored in memory 32 and/or storage 34. The processor 30 may be any type of computer processor or microprocessor capable of executing computer-executable code. The processor 30 may also include multiple processors that may perform the operations described below. As such, the memory 32 and/or the storage 34 of the data processing system 28 may be any suitable article of manufacture that can store the instructions. The memory 32 and/or the storage 34 may be ROM memory, random-access memory (RAM), flash memory, an optical storage medium, or a hard disk drive, to name a few examples. A display 36, which may be any suitable electronic display, may provide a visualization, a well log, or other indication of properties of the wellbore 16 based on the measurements 26.

In some embodiments, the data processing system 28 may include machine learning circuitry. The machine learning circuitry may provide operating functions of machine learning, including building, training, operating and/or generating predictions using a machine learning model. The machine learning circuitry may use visual machine learning and or artificial intelligence to accurately and dynamically correlate synthetic data and/or real data to predict, identify, and/or provide the predictions related to feature identification and parameter calculation. For instance, the data processing system 28 may use deep learning to train a feature detection model to determine locations of dips within the wellbore 16. In some instances, the deep learning may implement object detection to analyze the borehole images. That is, parameters associated with the dips (e.g., dip angle, amplitude) may be directly regressed by a deep learning detector similar to detection of objects in object detection methodologies.

As will be discussed in more detail below, the data processing system 28 (or processing circuitry of the downhole tool 12) may use the measurements 26 (e.g., borehole image data) to determine locations of dips within the wellbore 16. The information regarding the locations of dips may provide additional desirable data for use in wellbore 16 evaluation. For example, structural analysis, sedimentary analysis, fracture analysis, and the like regarding the wellbore 16 may be determined based on the location and orientation of the dips present therein. Using the presently disclosed embodiments, the dips located at various depths of the wellbore 16 may be acquired to determine the locations of hydrocarbon deposits within the wellbore 16 and the like.

As shown in FIG. 1, the wellbore 16 may be at least partially horizontal and drilled through two different beds of the geological formation 14. A formation boundary 38 represents the planar interface between these different strata of the geological formation 14. The wellbore 16 intersects the formation boundary 38 at a relative angle θ.

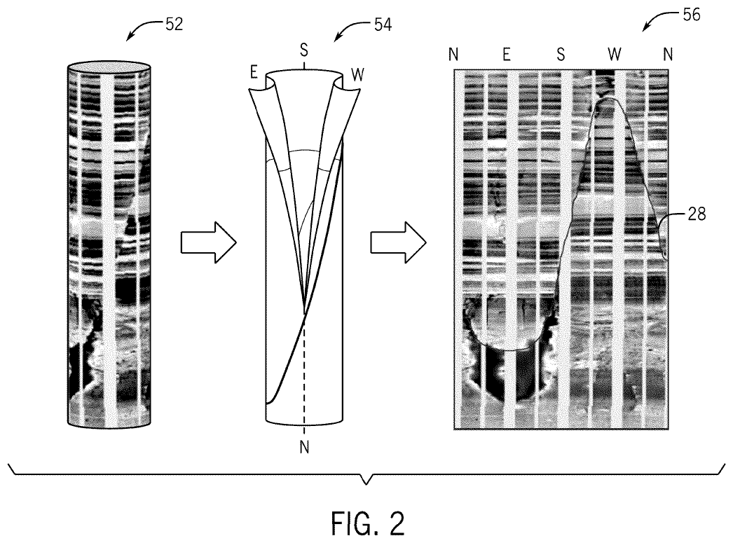

With the foregoing in mind, the borehole image data acquired via the downhole tool 12 may include high-resolution measurements that enable the data processing system 28 to characterize the location and orientation of the features (e.g., dips) within the wellbore 16. In one embodiment, as shown in FIG. 2, the downhole tool 12 may acquire imaging measurements (e.g., borehole image data) on a cylinder-shaped borehole by rotating the downhole tool 12 and scanning 3600 around the wellbore 16. After receiving the cylinder borehole image data 52, the data processing system 28 may convert the cylinder-shaped image (e.g., 54) into a flat image 56 and acquire certain imaging measurements as a result of unrolling the cylinder-shaped image. As such, the apparent azimuth angle reads on the horizontal axis of the flat image 56 and the vertical axis represents the measured depth. By inspecting the flat image 56, the downhole tool 12 may enable someone to identify any planar event crossing the wellbore 16 based on a one period sinusoid 58 depicted on the flat image 56. In one embodiment, the data processing system 28 may use the feature detection model to analyze the flat image 56 and identify the sinusoid 58 and extract associated parameters after it has been identified. For example, based on identification of the sinusoid 58 by the feature detection model, the data processing system 28 may output the dip orientation (dip inclination and azimuth), and/or the measured depth of the dip using the sinusoid characteristics (e.g. measured depth, amplitude, phase).

Accordingly, the presently disclosed embodiments are related to developing, training, and using a feature detection model to automatically extract one or more features (e.g., sinusoids 58, closed dips, additional features) that may be present in the borehole image data and parameterize characteristics associated with the features. In other words, the systems and techniques described herein may generate synthetic data to train the feature detection model, analyze prediction confidence of the feature detection model, and implement the feature detection model to predict features within borehole images.

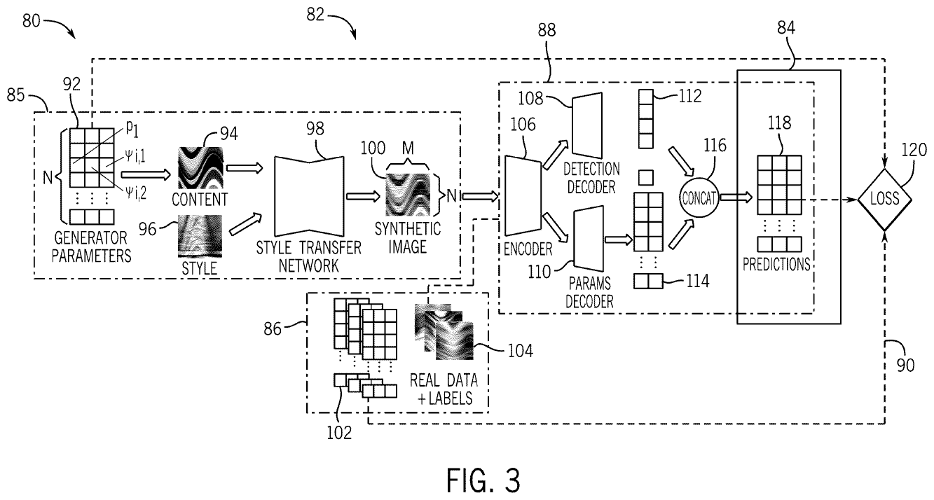

With this in mind, FIG. 3 is a schematic embodiment of a framework 80 of a feature detection model system 82. The feature detection model system 82 may output a feature detection model 84 that may be used to identify features within borehole images (e.g., flat image 56). In this manner, the framework 80 may include generating synthetic data, training the feature detection model 84 with the synthetic data and/or real data, and evaluating performance of the feature detection model 84. Further, one or more stages of the feature detection model system 82 may be included in the framework 80. It should be noted, the framework 80 of FIG. 3 is one non-limiting example of generation of the feature detection model 84 and that the illustrated stages are provided as examples and more, fewer, or different stages may be included in the framework 80. Further, the stages of the framework 80 may be executed by the data processing system 28, or any other suitable device(s) or controller(s).

As shown, the stages encompassed in the framework 80 may include a synthetic data generation stage 85, a real data generation stage 86, a model training stage 88, and a loss function generation stage 90. In some embodiments, the synthetic data generation stage 85 may include generating one or more parameters 92 (e.g., depth, phase, amplitude, inclinations, azimuths) for use in generation of a content dataset 94. In some embodiments, the one or more parameters 92 may be generated through random simulation of geometries similar to those observed in wellbores 16. For example, a random number of features (e.g., dips) may be generated synthetically. Synthetic generation of parameters (e.g., depths, phase, amplitude, inclinations, azimuths) of the random number of features may be guided as the parameters associated with features in the wellbore 16 may occur within an expected window (e.g., constraints). In this manner, the content dataset 94 may be generated by sampling random dip parameters (e.g., the one or more parameters 92) to generate various synthetic images that make up the content dataset 94. The synthetic images may resemble portions or patches of the wellbore 16. That is, the synthetic images may be generated to replicate wellbore images of different depths, locations, and/or one or more additional conditions. Generation of synthetic images that represent patches of the wellbore 16 may provide the content dataset 94 with various features common in wellbores 16. The synthetic images of the content dataset 94 may resemble the flat images 56 extracted from the cylinder borehole image data 52. In some embodiments, the content dataset 94 may be customized to resemble a specific wellbore based on desired features for extraction by the feature detection model 84. Generation of the content dataset 94 may resemble the flat images 56 extracted from cylinder borehole image data 52; however, in some instances, the content dataset 94 may include a plurality of un-stylized images. The un-stylized images may be homogeneous free of texture, resolution, and/or color distribution that may be present in real-world borehole images.

Borehole images (e.g., cylinder borehole image data 52) obtained from geological formations may have different characteristics depending on a location of the downhole tool 12 used for drilling. The characteristics may include texture, resolution, color distribution, and the like. As such, portions of boreholes, boreholes in particular locations (e.g., borehole at different depths), boreholes taken with various downhole tools, and the like may have distinct characteristics. Differences in characteristics captured in borehole images may lead to differences in feature selection from flat images associated with the borehole images. As such, a style dataset 96 may be applied to the content dataset 94 via a style transfer network 98 to add characteristics associated with borehole images to the content dataset 94. The style dataset 96 may include data associated with textures, colors, resolution, and/or one or more additional characteristics associated with boreholes, acquisitions techniques, cylinder borehole image data 52, and the like. For example, a particular wellbore may include a rough texture due to particular geological formations (e.g., vugs) within a region of the particular wellbore. In this manner, the cylinder borehole image data 52 extracted from the particular wellbore may include the rough texture. As such, generating style data corresponding to the rough texture may provide data for use in style transforms to increase a similarity of the content dataset 94 compared to borehole images. It should be noted, that characteristics of the wellbore 16 may vary with depth. As such, style data may be generated randomly to account for difference of characteristics of the wellbore 16 at differing depths.

In certain embodiments, the style dataset 96 may be applied to the content dataset 94 via the style transfer network 98. The style transfer network 98 may include a neural style transfer. The neural style transfer may manipulate the content dataset 94 to include characteristics included in the style dataset 96. As such, the style transfer network 98 may output a synthetic dataset 100. The synthetic dataset 100 may include various synthetic images made up of stylistic renderings of the content dataset 94 to match styles included in the style dataset 96. Various styles may be applied the style transfer network 98 to generate a desired number of synthetic images within the synthetic dataset 100. The synthetic dataset 100 may be used to train the feature detection model 84 in the model training stage 88.

In some embodiments, the framework 80 of the feature detection model system 82 may execute the real data generation stage 86. The real data generations stage 86 may use one or more parameters 102 generated from flat images 56 extracted from cylinder borehole image data 52 from various wellbores 16 to provide a real dataset 104 to the model training stage 88. The parameters 102 may include annotated data from manual dip picking and/or automatic dip picking processes. Addition of the real dataset 104 may limit a domain gap between the synthetic dataset 100 and flat images 56 in which the feature detection model 84 may be provided to make predictions. In this manner, in some instances a portion of data provided to the model training stage 88 may include real data. It should be noted, that in some embodiments, the feature detection model system 82 may include the synthetic dataset 100 without inclusion of the real dataset 104 or vice-versa.

In some embodiments, the framework 80 may implement the model training stage 88 to train the feature detection model 84. The model training stage 88 may include providing the synthetic dataset 100 and/or the real dataset 104 to an encoder 106. The encoder 106 may be a portion of an architecture of the feature detection model system 82. The encoder 106 may provide a semantic understanding of the synthetic dataset 100 and/or the real dataset 104. For example, the encoder 106 may analyze various objects present and/or the environment present in synthetic images of the synthetic dataset 100 and transform the analyzed data into structured representations that capture the meaning and context of the information. As such, the encoder 106 may identify and extract features from the synthetic dataset 100, map the synthetic dataset 100 into a representation space (e.g., via vectors), glean context from the synthetic dataset 100, and the like. The encoder 106 may output encoded data to the detection decoder 108 and/or the parameter decoder 110. The detection decoder 108 and the parameter decoder 110 may enable output of vectors of a particular vector length. That is, the detection decoder 108 may output a detection vector 112 and the parameter decoder 110 may output a parameter matrix 114 for each image of the provided data (e.g., synthetic dataset 100, real dataset 104). The outputs (e.g., detection vector 112, parameter matrix 114) may include data associated with features detected by the feature detection model 84 from the synthetic dataset 100 and/or the real dataset 104. The detection vector 112 may include information based on detection of a feature at various depths of each of the images of the provided data. The parameter matrix 114 may be based on values of the detection vector 112. That is, the detection vector 112 may be based on detection of a presence of features and/or an absence of features within each image of the provided data.

For example, consider a first synthetic image of the synthetic dataset 100 provided to train the feature detection model 84. The first synthetic image may represent a simulated portion of a specific wellbore. As such, the first synthetic image may be received by the encoder 106 to provide encoded data related to various depths represented with the first synthetic image to the detection decoder 108. The detection decoder 108 may interpret the encoded data and output the detection vector 112. A length of the detection vector 112 may be defined based on a number of depths represented in the first synthetic image. As such, the length of the detection vector 112 may include a number of rows that correspond to the number of depths of the first synthetic image. The number of depths may be partitioned based on supervised and/or unsupervised input. Values of each row of the detection vector 112 may correspond to a presence of a feature at a corresponding depth. The values of each row may be “1” if the feature is detected to be present and “0” if the feature is not detected by the feature detection model 84. In this manner, the detection vector 112 may identify the presence of features or the absence of features for each depth with the first synthetic image.

The parameter matrix 114 may be based on the values provided in the detection vector 112. In instances in which the feature detection model 84 detects the feature at a particular depth (e.g., value of “1”), the corresponding parameter matrix 114 for the particular depth may include values (e.g., parameters) associated with the feature. The values within the parameter matrix 114 may include a phase, an amplitude, an inclination, an azimuth, or a combination thereof. In instances in which the absence of the feature (e.g., value of “0”) at the particular depth is detected, the values of associated rows of the parameter matrix 114 may include any suitable value for each parameter. That is, in the absence of the feature, values of the parameter matrix 114 may not be used in training the feature detection model 84. In some embodiments, during the model training stage 88, the feature detection model system 82 concatenates 116 the detection vector 112 and the parameter matrix and outputs the prediction dataset 118. The prediction dataset 118 include an output of the feature detection model 84. The prediction dataset 118 may include a matrix of variable size for each image provided in the provided data. As such, the prediction dataset 118 may include a multidimensional array of various concatenated detection vectors 112 and parameter matrix 114.

In some embodiments, the framework 80 of the feature detection model system 82 may optionally include the loss function generation stage 90. The loss function generation stage 90 may be used to compare the prediction dataset 118 to the provided data (e.g., the synthetic dataset 100, the real dataset 104, a ground truth). As such, predictions generated by the feature detection model 84 may be compared to the parameters 92, 102. A loss function 120 may be used to inform training of the feature detection model 84 by the feature detection model system 82. In some instances the loss function 120 may be a combination of a detection loss term and a regression loss term. The detection loss term may be used to analyze the feature detection model's ability to learn depths of the features at each row of the detection vector 112. In some instances, the detection loss term may include an error margin of a threshold number of pixels (e.g., 5 pixels). That is, if the feature is predicted within the error margin of the threshold number of pixels from the ground truth it may not be categorized as a false detection of the feature. Further, the detection loss term may categorize false detections with those identified being more than the threshold number of pixels away from the ground truth. The regression loss term may be calculated based on a summation of the square root of the difference between parameters values extracted from the prediction dataset 118 and the ground truth. The detection loss term and the regression loss term may be combined as the loss function and may include a coefficient. The coefficient may be used to scale between the detection loss term and the regression loss term. The loss function may be used to determine a confidence probability of the feature detection model 84. The confidence probability may be used to determine to inform updates to the feature detection model 84.

In some embodiments, the framework 80 may be performed iteratively to train the feature detection model system 82. The confidence probability of the loss function generation stage 90 may be used to train the model to increase predictive power. In some instances, iterative training of the feature detection model system 82 may continue until a minimum threshold difference between iterations is satisfied (e.g., met). The threshold may be based on a percentage of features detected by the feature detection model 84. It should be noted, that in some embodiments, the framework 80 may include one or more additional stages. For example, a post-processing stage may be applied to the prediction dataset 118 output by the feature detection model system 82. The post-processing stage may include merging predicted features that may be attributed to a single feature within an analyzed image. For example, a sensitivity range may be selected that may include one or more rows corresponding to depths of images provided to the feature selection model. The post-processing stage may analyze predictions within the sensitivity range, select a prediction with a highest confidence probability and discard other predictions within the sensitivity range. In this way, multiple predictions of the same feature may be removed from the prediction dataset 118.

### Generating Synthetic Data

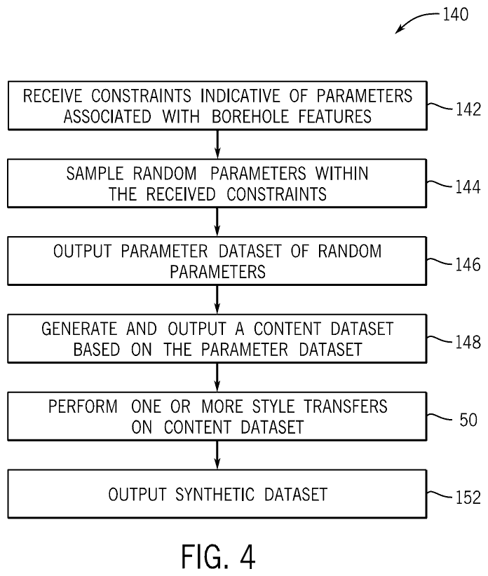

FIG. 4 provides an example process 140 for generating synthetic dataset 100. The synthetic dataset 100 may be used to train the feature detection model system 82. The synthetic dataset 100 may be generated to simulate borehole images. In some embodiments, the synthetic dataset 100 may include various images generated from parameters associated with features (e.g., dips, closed dips) found in borehole images. The process 140 may be performed within the feature detection model system 82 by the data processing system 28, a computing device, a controller, or any other suitable computing device(s) or controller(s). As described herein, the data processing system 28 may perform the process 140, but it should be understood that any suitable computing system may perform the process 140. Furthermore, the blocks of the process 140 may be performed in the order disclosed herein or in any suitable order. For example, certain blocks of the process 140 may be performed concurrently. In addition, in certain embodiments, at least one of the blocks of the process 140 may be omitted. Further, it should be noted, that certain blocks in process 140 may be iteratively performed.

At block 142 of the process 140, the data processing system 28 may receive one or more constraints (e.g., bounds) indicative of the parameters 92 associated with one or more features (e.g., borehole features). In some embodiments, the constraints may include a range of values of the parameters 92 associated with the features found in real-world borehole images. For example, the constraints may include a range of azimuth orientations associated with real-world borehole images (e.g., flat images 56). Further, in some instances the constraints may include a range, a spacing, and/or a contrast of the azimuth and/or inclination. In some embodiments, one or more faults (e.g., discontinuity) may be provided as the constraints. For example, geometric modeling associated with abrupt and/or discontinuous orientation changes may be included in the constraints indicative of the parameters 92 associated with the features.

At block 144, the data processing system 28 may sample random parameters within the constraints. In some embodiments, values within the constraints may be sampled to generate a parameter dataset. The parameter dataset may be generated by concatenating various generated parameters associated with the borehole features. For example, a randomized depth vector may be concatenated with a randomized phase vector to generate a parameter dataset including a set of feature parameters.

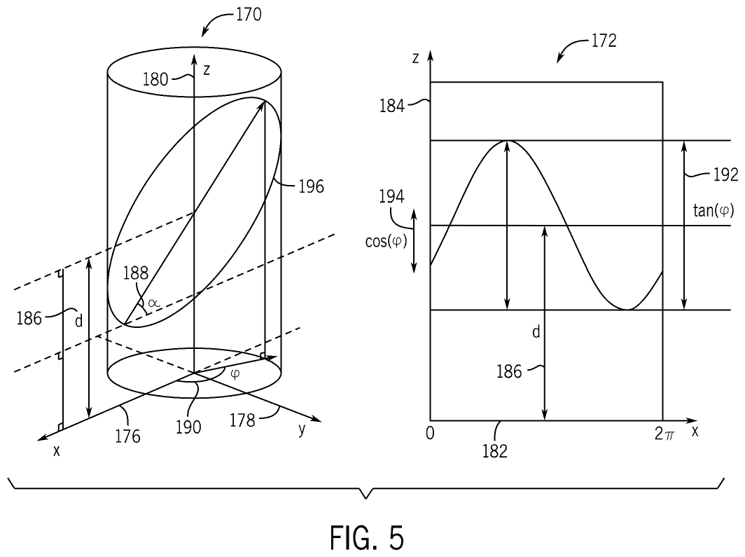

At block 146, the data processing system 28 may output the parameter dataset. The parameter dataset may include data associated with depth, phase, azimuth, amplitude, inclination, and the like of a simulated borehole. For example, FIG. 5 is a schematic embodiment illustrating a simulated cylinder borehole image 170 transformed into a sinusoid 172 (e.g., dip) upon “unwrapping.” To aid the discussion, a set of axes will be referenced. For example, a 3-D axis of the simulated cylinder borehole image 170 may include x-axis 176, a y-axis 178 and a z-axis 180. A two-dimensional axis of the sinusoid 172 may include an x-axis 182 and a y-axis 184. The simulated cylinder borehole image 170 and the sinusoid 172 may be parameterized. Parameterization of the simulated cylinder borehole image 170 illustrates a relationship between the parameter dataset and parameters that may be extracted from cylinder borehole image data 52. The simulated cylinder borehole image 170 may be parameterized by depth 186 (e.g., d), and a vector of parameters ψ={ψᵢ}_{1≤i≤S} with S being a dimension of a parameter space (e.g., 2, 3). The vector of parameters, ψ, may include an inclination angle (e.g., α) and an azimuth angle (e.g., φ) of the simulated cylinder borehole image 170. The dimension of the parameter space of the sinusoid 172 (e.g., dips) is two, however additional and/or alternative features of borehole images may have increased dimensions. Upon “unwrapping” a peak-to-peak amplitude 192 of the sinusoid 172 is the tangent of the inclination angle. An amplitude of a phase shift 194 of the sinusoid 172 is the cosine of the azimuth angle. In this manner, the parameters 92 randomly sampled to generate the parameters dataset may be representative of inputs related to extracting features of borehole images. For example, the feature may be extracted from a feature plane 196 (e.g., a dip plane). The feature plane 196 may represent a plane in which the feature is found in the simulated cylinder borehole image 170. As such, the parameter dataset may be used to generate artificial features that may be used as a content image representative of flat images of real-world boreholes.

Returning to FIG. 4, at block 148 of the process 140, the data processing system 28 may generate and output a content dataset 94 based on the parameter dataset (e.g., parameters 92). The content dataset 94 may include a plurality of content images (e.g., a plurality of un-stylized images) including artificial features (e.g., synthetically generated features) representative of features in borehole images.

At block 150 of the process 140, the data processing system 28 may perform one or more style transfers on the content dataset 94. In some embodiments, the style transfers may be associated with texture characteristics of borehole images, a real-world borehole, a well-logging system, and the like. In some instances, a style dataset 96 may be used to apply style to the content dataset 94 to enhance resemblance of the content dataset 94 to real-world data associated with boreholes. In some embodiments, the style dataset 96 may be generated by applying noise, filters, masks, or a combination thereof to the content dataset. In other embodiments, the style dataset 96 may be generated from a portion of a real-world borehole image. For example, the style dataset 96 may include a random patch from a particular real-world borehole image. Texture characteristics, resolution, color distribution, and the like may vary with depth of the borehole. As such, various random patches extracted from real-world borehole images may be used to represent various portions of the wellbore. In some embodiments, the style dataset 96 may be based on a particular wellbore and/or a particular field of wellbores. In this way, the style transfers may be associated with particular texture characteristics of borehole images from the particular wellbore and/or the particular field of wellbores.

Style transfers may be executed on the content dataset via a style transfer network 98. The style transfer network 98 may include a neural style transfer and/or one or more additional suitable image stylization effects. The stylization effects may manipulate the content dataset to include characteristics (e.g., texture, resolution, contrast) included in the style dataset 96. Various style transfers may be randomly applied to the content dataset 94. In some embodiments, random horizontal circular translations (e.g., horizontal rolls), random vertical stretch and crop (e.g., stretch and/or squeeze followed by cropping along a vertical axis), color transformation (e.g., randomized contrast, randomized brightness, etc.), or a combination may be applied to the content dataset 94. It should be noted, that a one or more style transfers may be applied to each image within the content dataset 94.

At block 152 of the process 140, the data processing system 28 may output the synthetic dataset 100. The synthetic dataset 100 includes content images transformed via style transfers into synthetic images. In some embodiments, the synthetic dataset 100 is generated by the feature detection model system 82 through receiving various inputs. The inputs may include a desired number of images for each set of parameters, a borehole array, the parameters 92, and the style dataset 96. Additionally and/or alternatively inputs may include limits such as a range of a number of features to generate per synthetic image. Each synthetic image may be generated with a matrix of size M×S. The data processing system 28 may save each generated synthetic image within the synthetic dataset 100. The synthetic dataset 100 is a simulated representation of a portion (e.g., a portion of an image, an entire image) of the flat images 54 extracted from the cylinder borehole image data 52 as illustrated in reference to FIG. 2. It should be noted, that while the process 140 is described as one continuous process implemented by the data processing system 28, in some embodiments, it is envisioned that the synthetic dataset 100 may be generated in a pre-processing step by another suitable computing device(s). For example, the synthetic dataset may be retrieved for use in training the feature detection model 84 subsequent to generation.

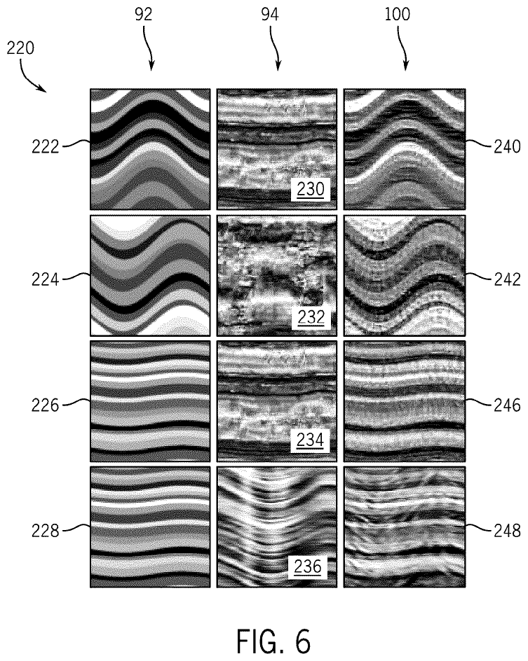

FIG. 6 is a schematic embodiment of a protocol 220 for generating synthetic data for use in training the feature detection model system 82. The protocol 220 includes various images extracted from the content dataset 94, the style dataset 96, and the synthetic dataset 100 as previously referenced in relation to FIG. 3. It should be noted, that the protocol 220 is a non-limiting embodiment and one or more additional types of content images and/or style transfers are envisioned. In some embodiments, a first content image 222, a second content image 224, a third content image 226, and a fourth content image 228 may represent a portion of the content dataset 94. A first style image 230, a second style image 232, a third style image 234, and a fourth style image 236 may represent a portion of the style dataset 96. The content images 222, 224, 226, 228 may represent artificial sinusoids. The style images 230, 232, 234, 236 may represent random real-world borehole images including differences in characteristics of real-world borehole images such as differences in texture, resolution, color distribution, and the like. For example, the second style image 232 may have a lower resolution than the third style image 234.

In certain embodiments, a first synthetic image 240, a second synthetic image 242, a third synthetic image 246, and a fourth synthetic image 248 are generated by applying the style images 230, 232, 234, 236 to the content images 222, 224, 226, 228. That is, each row of the protocol 220 may represent image stylization of the content images 222, 224, 226, 228 to output the synthetic images 240, 242, 244, 246 representative of real-world borehole images. For example, the first style image 230 may be applied to the first content image 222 to generate the first synthetic image 240. As shown, the first synthetic image 240 includes artificial features from the first content image 222 and texture from the first style image 230. In this manner, the first synthetic image 240 may be saved to the synthetic dataset 100 for use in training the feature detection model 84 to predict features from real-world bore hole images. It should be noted, that in some embodiments, the feature detection model system 82 may include applying one or more style images to each content image. Additionally and/or alternatively, a single style image may be applied to various content images within the content dataset 94.

### Training and Evaluating the Feature Detection Model

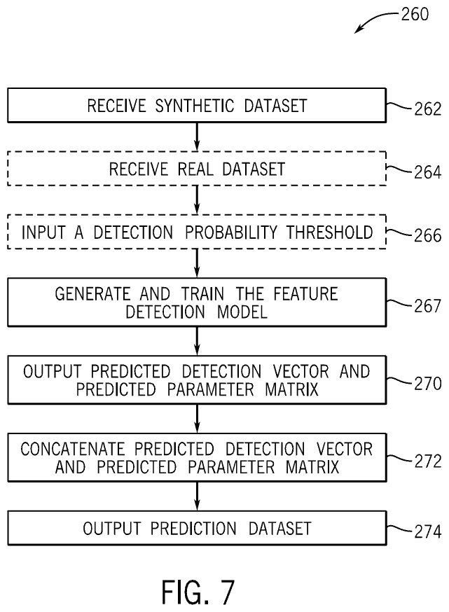

FIG. 7 provides a process 260 for training the feature detection model system 82 to output a prediction dataset. The prediction dataset may include predictions of features found in the synthetic dataset 100 (e.g., training dataset). In some embodiments, the prediction dataset may be used to evaluate the feature detection model 84. The process 260 is described as being performed by the data processing system 28 but a computing device, a controller, or any other suitable computing device(s) or controller(s) may also perform the process 260. Furthermore, the blocks of the process 260 may be performed in the order disclosed herein or in any suitable order. For example, certain blocks of the process 260 may be performed concurrently. In addition, in certain embodiments, at least one of the blocks of the process 260 may be omitted. Further, it should be noted, that certain blocks in process 260 may be iteratively performed.

At block 262 of the process 260, the data processing system 28 may receive the synthetic dataset 100. The synthetic dataset 100 may be retrieved from a database and/or generated by the feature detection model system 82 as described in FIG. 4.

At block 264 of the process 260, the data processing system 28 may receive a real dataset 104. The real dataset 104 may include real-world borehole images. It should be noted, that block 264 of the process 260 is an optional step of the process 260. For example, in some embodiments the data processing system 28 may only receive synthetic dataset 100. In other embodiments, the data processing system 28 may receive the real dataset 104. In some embodiments, real-world bore hole images may be available for use in the real dataset 104. In some embodiments, combining the real dataset 104 with the synthetic dataset 100 may enhance a performance of the feature detection model system 82. Enhancement of the performance of the feature detection model system 82 may improve generalization capabilities of the feature detection model 84 by introducing the real dataset 104 composed of real-world borehole images from a variety of wellbores. Inclusion of data from the variety of wellbores may reduce influence of possible imperfections in the synthetic dataset 100 that may be added during style transfer. As such, inclusion of the real dataset may reduce a domain gap (e.g., discrepancy of predicting features) between synthetic images and real-world bore hole images.

At block 266 of the process 260, the data processing system 28 may receive a detection probability threshold. In some embodiments, the detection probability threshold may be received by the feature detection model system 82 to account for features that may not appear entirely in a single image. For example, in some embodiments, the synthetic dataset 100 and/or the real dataset 104 may represent a patch size of a set number of pixels (e.g., 360×360 pixel). As such, the artificial features may not appear entirely on a given patch due to a large amplitude of particular features. That is, a particular sinusoid may have an amplitude larger than the set number of pixels. In this manner, a multiscale approach may be applied by the data processing system 28 to account for features of various scales. In some instances, the images may be scaled to have apply a squeezing effect on the features. Squeezing the features via rescaling may increase detection of features with high amplitudes. In order to aggregate all detections across the various scales, the detection probability threshold may be selected to correspond to a maximum probability along the various scales at each depth of the feature and corresponding parameters (e.g., inclination, azimuth, phase, amplitude). In certain embodiments, a minimum amplitude may be defined within the detection probability threshold for each scale setting analyzed. The minimum amplitude may allow features at larger scales to detect low amplitude dips that may be squeezed to straight lines. It should be noted, that in some embodiments, the process 260 may not include the block 266. For example, the multiscale approach may be omitted in instances in which the patch size is of a single scale.

At block 268 of the process 260, the data processing system 28 may generate and train the feature detection model 84. The feature detection model 84 may be trained on a combination of the synthetic dataset 100, the real dataset 104, and various parameters that may include the detection probability threshold. In certain embodiments, the feature detection model 84 may be trained on a subset of the synthetic dataset to enhance a predictive strength of the model as discussed further in regards to Table 2 described below.

At block 270 of the process 260, the data processing system 28 may output the predicted detection vector 112 and the predicted parameter matrix 114 based on the trained feature detection model 84. A length of the detection vector 112 may be defined based on a number of depths represented in each image of the synthetic dataset 100. As such, the length of the detection vector 112 may include a number of rows that correspond to the number of depths of the detection vector 112. For each row of each image of the synthetic dataset 100, the detection vector 112 includes a confidence probability of an existence of a feature at a corresponding depth. The parameter matrix 114 corresponds to the confidence probability of the detection vector 112. In some embodiments, at block 272 of the process 260, the data processing system 28 may concatenate the detection vector 112 and the parameter matrix 114 based on the trained feature detection model. A prediction dataset is output by the data processing system 28 at block 274 of the process 260. The prediction dataset may be evaluated using a loss function to analyze a predictive power of the generated feature detection model 84.

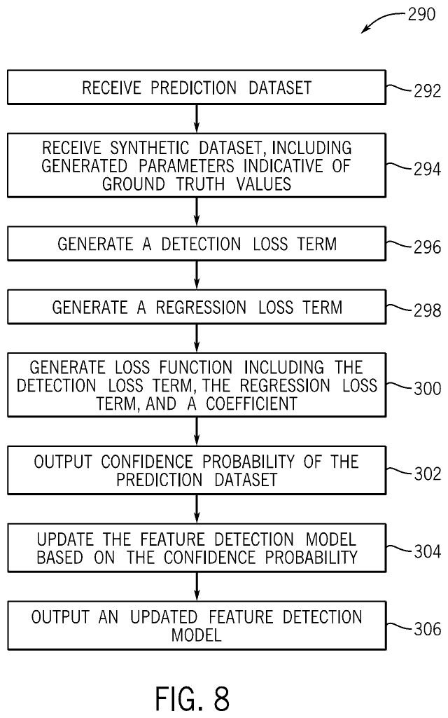

FIG. 8 is a process 290 for generating a loss function to generate confidence probabilities associated with the prediction dataset of the feature detection model. The loss function may be used to evaluate the feature detection models 84 ability to detect features within the synthetic dataset 100. Based on the resulting loss function, the feature detection model 84 may be iteratively trained to increase the predictive power. The process 290 may be performed by the data processing system 28 but may also be implemented via a computing device, a controller, or any other suitable computing device(s) or controller(s). Furthermore, the blocks of the process 290 may be performed in the order disclosed herein or in any suitable order. For example, certain blocks of the process 290 may be performed concurrently. In addition, in certain embodiments, at least one of the blocks of the process 290 may be omitted. Further, it should be noted, that certain blocks in process 290 may be iteratively performed.

At block 292 of the process 290, the data processing system 28 may receive the prediction dataset as described in FIG. 7. At block 294 of the process 290, the data processing system 28 may receive the synthetic dataset 100 including the parameters 92 indicative of one or more ground truth values associated with features included within each synthetic image of the synthetic dataset 100. The ground truth values may include a depth, an inclination, an azimuth, an amplitude, a phase, and the like associated with each feature within each of the synthetic images. At block 296 of the process 290, the data processing system 28 may generate a detection loss term. In some embodiments, the detection loss term is shown in Equation 1,

$${L}_{detection} = {\sum }_{i = 1}^{M} {w}_{i} FL ( {C}_{i} , {𝕀}_{feature} ( i ) ) \qquad Equation 1$$

where Cᵢ is the prediction confidence at the i-th row of the detection vector 112, [symbol] _{dip}(i) is an indicator of existence of a feature at the i-th row of the detection vector 112, and FL is the focal loss. In some embodiments, the focal loss is an input indicative of an error margin (e.g., 1 pixel, 5 pixels, 10 pixels, etc.). The error margin defines an area relative to the ground truth value accepted as a valid prediction. That is, if a prediction of the feature is within the error margin, it may not be penalized by the detection loss term as a false feature detection event. Additionally, in some embodiments, a weight vector, w, may be included in the loss detection term to provide a weight for misclassified features that are within the error margin of the ground truth values.

At block 298 of the process 290, the data processing system 28 may generate a regression loss term. In certain embodiments, the regression loss term is shown in Equation 2,

$${L}_{regression} = {\sum }_{i = 1}^{M} {𝕀}_{feature} ( i ) \sqrt{\vert {ψ}_{i} - {\hat{ψ}}_{i} \vert} \qquad Equation 2$$

where [symbol] _{dip}(i) is an indicator of existence of a feature at the i-th row of the parameter matrix 114, and ψᵢ correspond to values of the prediction dataset and \hat{ψ}ᵢ corresponds to corresponding ground truth values.

At block 300 of the process 290, the data processing system 28 may generate the loss function. The loss function is shown in Equation 3,

$${L}_{total} = {λ}_{det} {L}_{detection} + {L}_{regression} \qquad Equation 3$$

where L_{detection} is the loss detection term, L_{regression} is the loss regression term, and λ_{det} is a coefficient that may be used to vary a balance between the loss detection term and the loss regression term. In some instances the coefficient may be 0.05, 0.1, 0.15, etc.

At block 302 of the process 290, the data processing system 28 may output a confidence probability of the prediction dataset. The confidence probability may be based on quantitative analysis of the prediction dataset using the loss function. At block 304 of the process 290, the data processing system 28 may use the confidence probability generated by the loss function to update the feature detection model 84 to increase predictive power. In some instances, the data processing system 28 may continue iterative training of the feature detection model 84 until a threshold percentage is met. The threshold percentage may include a percentage (e.g., 50%, 70%, 80%, etc.) of features predicted by the feature detection model 84. At block 306, the data processing system 28 may output an updated feature detection model. In some embodiments, post-processing may be performed on the prediction dataset generated by the data processing system 28 and/or the feature detection model system 82.

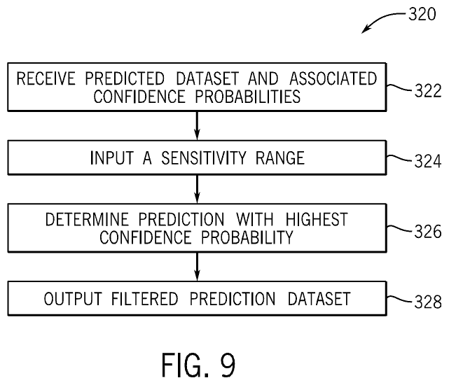

With this in mind, FIG. 9 is a process 320 for applying one or more post processing steps to the prediction dataset. The process 320 may be performed by the data processing system 28, but it should be understood that a computing device, a controller, or any other suitable computing device(s) or controller(s) may perform the process 320. Furthermore, the blocks of the process 320 may be performed in the order disclosed herein or in any suitable order. For example, certain blocks of the process 320 may be performed concurrently. In addition, in certain embodiments, at least one of the blocks of the process 320 may be omitted. Further, it should be noted, that certain blocks in process 320 may be iteratively performed.

At block 322, the data processing system 28 may receive the prediction dataset and associated confidence probabilities. In some embodiments, the associated confidence probabilities may be calculated using the loss function described in FIG. 8. At block 324 of the process 320, the data processing system 28 may receive a sensitivity range. The sensitivity range may be based on a sensitivity range to filter predictions within the prediction database. In some instances, the sensitivity range may filter the prediction value to reduce multiple identifications of a particular feature within an image. Filtering the prediction dataset may select a prediction corresponding to a greatest prediction confidence within the sensitivity range.

At block 326 of the process 320, the data processing system 28 may determine a prediction with a highest confidence probability. The highest confidence probability may be based on a threshold. The threshold may be applied to the confidence probability to filter feature predictions. In some instances, the data processing system 28 may remove additional predictions from the prediction dataset.

At block 328, the data processing system 28 may output a filtered prediction dataset. The filtered prediction dataset may include fewer predictions than the prediction dataset as multiple identification of particular features within images of the prediction dataset may be removed.

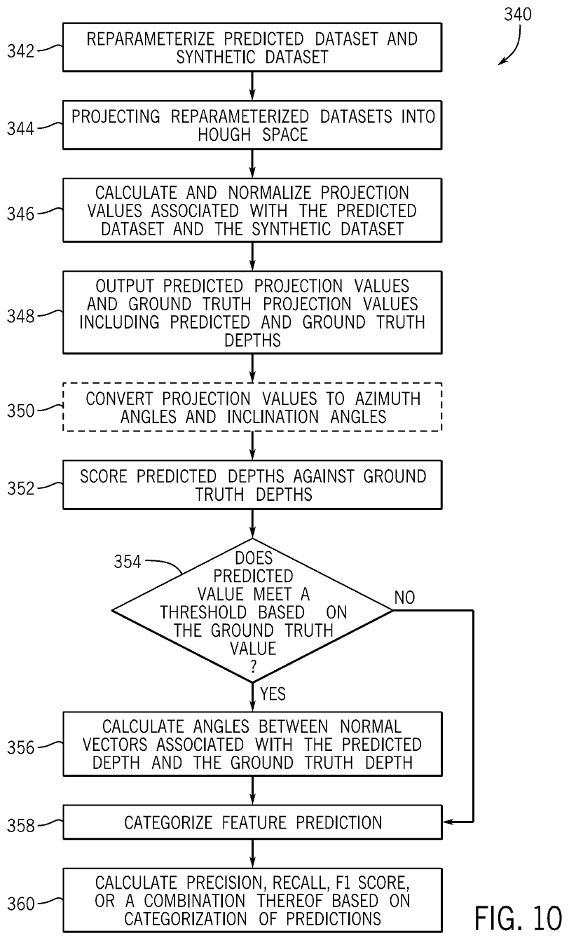

FIG. 10 is a process for validating the feature detection model 84. In some embodiments, reparametrizing of a validation dataset and comparison of outputs of the feature detection model 84 to ground truth values. In some embodiments, the prediction dataset as discussed with reference to FIGS. 7-9 may include confidence probabilities associated with prediction of features in data (e.g., synthetic dataset 100, real dataset 104, additional data) provided by the feature detection model 84. In certain embodiments, the predictive power of the feature detection model 84 may be based on detection of features (e.g., feature found, no feature found, “1”, “0”). However, reparameterization of the prediction dataset may be performed to output projection values associated with properties found in real-world borehole images (e.g., depths, angles). Such reparameterization may allow for further categorization of the predictive power of the feature detection model compared to the ground truth values. As such, the process 340 outlines reparameterization, categorization, and calculation of precision and recall of predictions generated by the feature detection model 84.

The process 340 may be performed by the data processing system 28, but a computing device, a controller, or any other suitable computing device(s) or controller(s) may perform the process 340. Furthermore, the blocks of the process 340 may be performed in the order disclosed herein or in any suitable order. For example, certain blocks of the process 340 may be performed concurrently. In addition, in certain embodiments, at least one of the blocks of the process 340 may be omitted. Further, it should be noted, that certain blocks in process 340 may be iteratively performed.

At block 342 of the process 340, the data processing system 28 may reparametrize the prediction dataset and the ground truth values (e.g., parameters used to generate synthetic dataset 100). In some embodiments, the data processing system 28 may retrieve the prediction dataset, the filtered prediction dataset, the synthetic dataset 100, the real dataset 104, the parameters 92 associated with the synthetic dataset 100, the parameters 102 associated with the real dataset 104, or a combination thereof. In some embodiments, reparameterization may be performed by computing the normal vector to the feature plane 196 (e.g., dip plane). Equation 4 illustrates a reparameterization vector used for reparameterization of parameters associated with the features of the prediction dataset and the ground truth values,

$$\vec{v} ( a , b , c ) = \{ \begin{matrix}a & = sin ( α ) cos ( φ ) \\ b & = sin ( α ) sin ( φ ) \\ c & = - cos ( α )\end{matrix} \qquad Equation 4$$

where α is the inclination angle and p is the azimuth angle. The sign of c may be determined based on an orientation of a z-axis of the borehole. The reparameterization vector and an associated depth for each feature distinctly define each feature within each image of the prediction dataset (e.g., reparametrized prediction dataset).

At block 344 of the process 340, the data processing system 28 may project the reparameterization vector into a chosen Hough space. For example, Equation 5 illustrates projection of the reparameterization vector to generate projection values.

$$\vec{v} ( a , b , c ) = \{ \begin{matrix}{a}_{proj} & = sin ( α ) cos ( φ ) \\ {b}_{proj} & = sin ( α ) sin ( φ )\end{matrix} \qquad Equation 5$$

At block 346, the data processing system 28 may calculate and normalize the projection values associated with the prediction dataset and the synthetic dataset. In some embodiments, a normal vector of the projected values may be computed using Equation 6.

$$\vec{v} ( {a}_{proj} , {b}_{proj} ) = \{ \begin{matrix}{a}_{proj} & = \sqrt{1 - cos ( α )} cos ( φ ) \\ {b}_{proj} & = \sqrt{1 - cos ( α )} sin ( φ )\end{matrix} \qquad Equation 6$$

where the normal vector of a and b may correspond to values between −1 and 1 for each feature. Normalization between 0 and 1 of output of Equation 6 may be performed.

At block 350, the data processing system 28 may convert the projection values into the azimuth angles and the inclination angles. In some embodiments, the azimuth angles and the inclination angles are calculated as shown in Equation 7.

$$\{ \begin{matrix}φ & = arctan ( \frac{{b}_{proj}}{{a}_{proj}} ) \\ α & = arccos ( 1 - ( {a}_{proj}^{2} + {b}_{proj}^{2} ) )\end{matrix} \qquad Equation 7$$

It should be noted, that in some embodiments, block 350 of the process 340 is an optional step.

At block 352 of the process 340, the data processing system 28 may score one or more predicted depths extracted from the prediction data to associated ground truth depths. For example, the score may be based on an ability of the feature detection model 84 to predict features within a threshold. The threshold may be based on a sensitivity of a number or pixels within the image as compared to the ground truth values associated with a location of the features. In some instances, the sensitivity may be set to 2 pixels, 5 pixels, 8 pixels, 10 pixels, and the like. If the feature is detected by the feature detection model 84 within the threshold it may be provided a score indicative of a correct depth prediction.

At block 354 of the process 340, the data processing system 28 may determine if a predicted value is within the threshold with respect to the ground truth value for each feature. In some embodiments, the threshold may not be met and the process 340 may proceed to block 358. In some embodiments, the threshold may be met and the process may proceed to block 356. At block 356, the data processing system 28 may calculate angles between the normal vectors, calculated in Equation 6, associated with the predicted values and the ground truth values. That is, if the feature detection model 84 predicts a depth of the feature within the threshold additional parameters associated with the feature may be calculated.

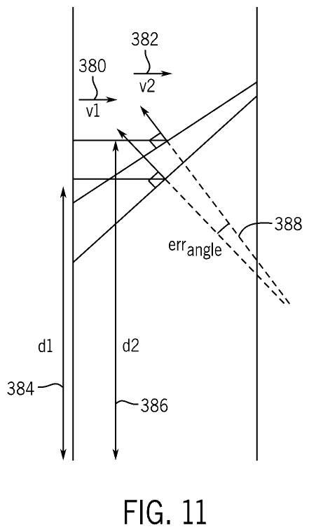

For example, FIG. 11 is a schematic embodiment illustrating comparison of a predicted feature represented by a normal vector 380 and a ground truth value represented by a ground truth vector 382. A predicted depth 384, a ground truth depth 386, and associated vectors may be used to calculated an error angle 388. The error angle 388 is calculated between the normal vector 380 and the ground truth vector 382. In some embodiments, the error angle 388 may be compared to an angle threshold to determine a categorization (e.g., false positive, true positive, false negative) of the predicted feature.

Retuning to FIG. 10, at block 358 of the process 340, the data processing system 28 may categorize the feature prediction. In some embodiments, the feature prediction may be based on the error angle 388. The feature prediction may be categorized as a false positive (e.g., FP) if the predicted depth 384 is not within about 5-pixel range of the ground truth depth 386. The feature prediction may be categorized as a true positive (e.g., TP) if the error angle 388 is less than about 5 degrees. The feature prediction may be categorized as a false positive (e.g., FP) if the predicted depth 384 is within the about 5-pixel range of the ground truth depth 386 and if the error angle 388 is more than the about 5 degrees. Predictions may be classified as a false negative (e.g., FN) if the feature detection model 84 misses assigning a feature to a ground truth feature (e.g., missing feature prediction). In instances, in which the process 340 proceeds from block 354 to block 358 the feature prediction is categorized as the false positive.

At block 360 of the process 340, the data processing system 28 may calculate a precision, a recall, an F1 score, or the like based on categorization of the feature predictions. The precision may measure an accuracy of feature predictions made by the feature detection model 84. The recall may measure an ability of the feature detection model 84 to predict features as the true positive. The F1 score may measure a harmonic mean of the precision and the recall of the feature detection model 84. In some embodiments, the precision is defined as

$$\frac{T P}{( T P + F P )} .$$

In some embodiments, the recall is defined as

$$\frac{T P}{( T P + F N )} .$$

In some embodiments, the F1 score is defined as

$$\frac{2 \times Precsiion \times Recall}{( Precision + Recall )} .$$

In some embodiments, the precision, recall, and the F1 score may be used to determine the predictive power of the feature detection model 84.

### Validating the Feature Detection Model on Real Data

In some embodiments, the feature detection model 84 may be validated and/or tested on flat images 56 extracted from cylinder borehole image data 52 taken from a geological formation 14. A validation dataset may include data from one or more wellbores. In an embodiment, the validation dataset may include data associated with Well A and Well B. A Well A dataset may include an image of about 5×10⁶ pixels in depth and about 360 pixels in width. The dataset may include about 9,000 features manually extracted by experts in the field. A Well A dataset may include an image about 3×10⁶ pixels in depth and about 360 pixels in width. The dataset may include about 14,000 features manually extracted by experts in the field. The feature detection model 84 may be used to predict the features of the validation dataset (e.g., Well A dataset, Well B dataset).

For example, Table 1 shows a comparison between the feature detection model 84 and two auto dip picking systems (e.g., auto(35, 15), auto(40,6)). Predictions related to the Well A dataset show that the feature detection model 84 predicted features with increased precision. The feature detection model 84 had an increased precision (+13.6% over auto(35,15) and +3.8% over auto(40,6)), enhanced recall (+3.1% over auto(40,6)) and increased F1 score (+1.8% over auto(35,15) and +3.3% over auto(40,6)) with respect to the Well A dataset. The feature detection model 84 had an increased precision (+18.1% over auto(35,15) and +13% over auto(40,6)), enhanced recall (+8.5% over auto(40,6)) and increased F1 score (+18.1% over auto(35,15) and +14.6% over auto(40,6)) with respect to the Well B dataset.

TABLE 1
Quantitative Comparison between The Feature
Detection Model and Auto Dip Picking

| | | |
|---|---|---|
| Precision | Recall | F1 Score |

Well A Dataset

| | | | |
|---|---|---|---|
| Auto (35, 15) | 17.3 | 76.9 | 38.3 |
| Auto (40, 6) | 37.1 | 36.2 | 36.8 |
| Feature Detection Model | 40.9 | 39.3 | 40.1 |
| Feature Detection Model | 44.3 | 41.6 | 42.8 |
| with Real Data | | | |

Well B Dataset

| | | | |
|---|---|---|---|
| Auto (35, 15) | 27.0 | 97.3 | 42.5 |
| Auto (40, 6) | 32.1 | 83.4 | 46.0 |
| Feature Detection Model | 45.1 | 91.9 | 60.6 |
| Feature Detection Model | 48.0 | 93.2 | 64.6 |
| with Real Data | | | |

In some embodiments, the feature detection model 84 may be provided a real dataset during training. Table 1 shows the comparison of the training without the real dataset and with the real data set. The precision, the recall, and the F1 Score increase when the real dataset is used for training of the feature detection model 84. In some embodiments, providing the real dataset during training may improve predictions of the feature detection model 84 by improving generalization capabilities and reduce an influence of possible imperfections in the synthetic dataset 100 on the feature detection model 84.

In certain embodiments, the feature detection model 84 may be trained on a subset of the synthetic dataset to enhance a predictive strength of the model. For example, the feature detection model 84 may be trained using synthetic data generated using style images obtained from real-world images of a borehole similar to the images provided to the trained feature detection model for predictions. Generally, a predictive power of the trained feature model may increase when synthetic images including style images extracted from a similar wellbore are used during training. Table 2 is a quantitative evaluation of a precision and recall of the trained feature detection model 84 trained with synthetic data generated using style images obtained from similar and different real-world images of a borehole. As shown, example R and example S have higher precision and recall when compared to example T and Q. That is, when style transfers are applied to match a source of the validation data with the content dataset 94 the predictive power of the feature detection model 84 increases.

TABLE 2
Quantitative evaluation of using different
wells for generation of the style dataset

| | Source of | Source of | | |
|---|---|---|---|---|
| Example | Style Image | Validation Data | Precision | Recall |
| R | Well A | Well A | 40.9 | 39.3 |
| S | Well B | Well B | 45.1 | 91.9 |
| T | Well A | Well B | 0.08 | 0.99 |
| Q | Well B | Well A | 0.03 | 0.90 |

### Generalization of the Feature Detection Model

The feature detection model 84 discussed in reference to FIGS. 3-11 is described in reference to predicting a presence of sinusoids or dips in borehole images. However, in some instances, upon “unwrapping” of cylindrical borehole images a plane (e.g., a geological layer) may be non-planar. That is, borehole images may include features exhibiting curvature due to a folded nature of the feature along a bed boundary. Folded layers may include features from a geological point of view that may outside existing parametrization protocols. Additionally and/or alternatively, planar features may be formed upon change in a drilling direction. As a drill (e.g., downhole tool) passes through a planar layer change in orientation may induce a reparameterization between a first orientation and a second orientation. As such, consideration of reparameterization may be advantageous. The feature detection model 84 disclosed herein may be generalized to parameterize and predict said features.

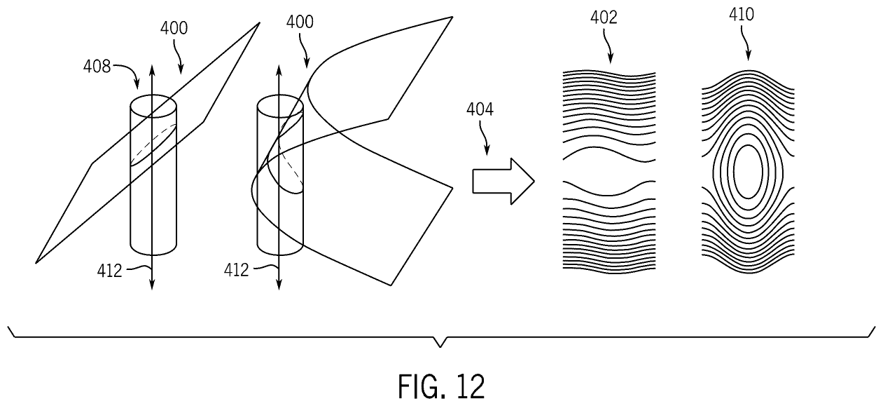

FIG. 12 is a schematic embodiment of features associated with borehole images obtained via the well-logging tool of FIG. 1 including a sinusoid and a closed dip. When a feature plane 400 is planar a sinusoid 402 is output upon transformation 404 (e.g., unwrapping). However, in instances in which a feature has a non-planar cross section 406 “unwrapping” of a cylinder borehole 408 may result in a closed dip 410. As such, additional parameters may be considered for feature detection (e.g., closed dip feature detection) for feature that are not classified as sinusoids. In certain embodiments, a folded layer (e.g., bed boundary, feature) may be modeled by a parabola, cz²+x=β, where c and β control a size of the parabola and a corresponding position along an x-axis, and where β measures how far the parabolic vertex is from the center of the cylinder borehole 408. In some embodiments, c≥0 and β is two real numbers. In some embodiments, the parametric equations may be used to determine an intersection of a plurality of three-dimensional shapes as shown in Equation 8,

$$( \begin{matrix}R cos ( θ ) \\ R sin ( θ ) \\ \pm \sqrt{\frac{β - R cos ( θ )}{c}}\end{matrix} ) \qquad Equation 8$$

where, R is the diameter of the cylinder borehole 408 divided by two. In some instances, one or more branches of the parabola may intersect the cylinder borehole 408 at a plurality of different planes. When the branches points of intersection are a certain distance away the intersection may form different features. For example, when β is greater than R a sinusoid may begin to show in the transformation 404 as shown by the sinusoid 402. When β is less than −R there may be no intersection of a cylinder borehole. When β is greater than or equal to −R and less than or equal to R, the feature may be a closed dip. For example, the non-planar cross section 406 intersects the cylinder borehole 408 at two planes and after the transformation 404 may be displayed as the closed dip 410.

In certain embodiments, due to a rotational invariance along a z-axis 412 of the cylinder borehole 408 a parameter of azimuth may be substituted in to Equation 8. Equation 9 includes the parameter of azimuth, φ,

$$( \begin{matrix}R cos ( θ ) \\ R sin ( θ ) \\ \pm \sqrt{\frac{β - R cos ( θ - φ )}{c}}\end{matrix} ) \qquad Equation 9$$

where, the definition domain of each closed dip is D_{θ}={θϵ[0,2π [s.t. β−R cos(θ−φ)]≥0]}c≥0, and β≥0, and φ. From Equation 9, triplets (e.g., (c,β,φ), p) and (−c,−β,φ+π[2π])) may be identified as two sets of parameters that may yield the output of the closed dip 410. As such, to ensure the feature detection model system 82 is trained consistently c may be selected to be a positive value. In this manner, when varying β in a sinusoidal regime (e.g., R, R+100) the closed dip 410 may occur. In instances, in which extrema of the paraboloid move away from the cylinder borehole 408 branches may converge to the feature plane 400 and the intersections become sinusoidal, as shown by the sinusoid 402. The feature detection model system 82, may be trained to predict β and c for each closed dip.

In some embodiments, the feature detection model 84 may be used to predict a property of borehole images including the closed dip 410. The feature detection model 84 may be trained on synthetic images that may include circular translations. In this way, the feature detection model 84 may be trained to predict positions of closed dips through color difference between a left and a right half of borehole images. Further, in some instances, the feature detection model 84 may be modified to output an array of logits at every depth of a borehole image. The array of logits may provide depth information of closed dips as portions of closed dips may share a similar depth. Generalization of the feature detection model 84 to predict closed dips was executed and a validation dataset was used to assess the prediction power of the generalized feature detection model. The validation dataset used to assess the prediction power of the generalized figure detection model includes three wells (e.g., 1.2 km in length) containing a total of five zones covered with closed dips. The generalized feature detection model identified three of the five zones while yielding two false detections. The two false detections were a result of the generalized feature model identifying a change in direction of sinusoids as closed dips. The generalized feature detection model may be used to extract complex features from borehole images.

Technical effects of the disclosed embodiments include a feature detection model 84 predicting features of a borehole image taken in the context of oil and/or gas exploration. The feature detection model 84 may be trained using a synthetic dataset 100 generated using parameters 92 simulating features of a borehole. The synthetic dataset 100 may include a plurality of images. The plurality of images may include context data (e.g., representative of features of borehole) stylized using a plurality of style transfers indicative of texture, resolution, color distribution, and the like. The feature detection model 84 may be evaluated using a validation dataset. The validation dataset may include borehole images extracted from one or more boreholes. The features detection model 84 may be particularly beneficial in feature selection of wellbores with styles similar to styles included in the synthetic dataset 100. The feature detection model 84 may help streamline feature detection. By streamlining feature detection through incorporation of the feature detection model 84 and the generalized feature detection model, overall performance in consistent, reproducible, and efficient prediction of features from borehole images is improved. The disclosed techniques result in reduced may result in reduced computational costs associated with less time spent analyzing borehole images to perform feature selection. Further, deployment of the presently disclosed techniques may provide improved efficiency and performance of feature detection. Additionally, the feature detection model 84 may be used in-situ (e.g., during operation of the well-logging system 10) to analyze borehole images in real-time.

The subject matter described in detail above may be defined by one or more clauses, as set forth below.

A system is provided that includes a processing circuitry and a memory, accessible by the processing circuitry, the memory storing instructions that, when executed by the processing circuitry cause the processing circuitry to perform operations. The operations may include generating synthetic dataset representative of a plurality of synthetic borehole images and training a feature detection based on the synthetic dataset, wherein the feature detection model predicts one or more features associated with a plurality of borehole images at one or more depths, one or more parameters associated with the one or more features, or both. The operations may also include generating a prediction dataset including a predicted detection vector and a predicted parameter matrix based on the feature detection model, wherein the predicted detection vector includes one or more indications of the one or more features at the one or more depths, and wherein the predicted parameter matrices include the one or more parameters associated with the one or more features.

The system of the preceding clause, wherein the processing circuitry performs the operations comprising receiving one or more constraints associated with the one or more parameters, sampling the one or more parameters randomly within the one or more constraints, and generating a parameter dataset based on the one or more sampled parameters.

The system of any preceding clause, wherein the processing circuitry performs the operations comprising generating a content dataset based on the parameter dataset, wherein the content dataset comprises a plurality of un-stylized images, performing one or more style transfers on the content dataset, wherein the one or more style transfers comprise one or more neural style transfers, and generating the synthetic dataset based on the one or more styles transfers applied to the content data.

The system of any preceding clause, wherein the processing circuitry performs the operations comprising receiving a real dataset comprising one or more additional parameters extracted from one or more additional borehole images associated with one or more real-world boreholes, and training the feature detection model with the real dataset.

The system of any preceding clause, wherein the processing circuitry performs the operations comprising inputting a detection probability threshold comprising a maximum probability along one or more scales at each depth of the one or more features and the one or more parameters, and training the feature detection model based on the detection probability threshold.

The system of any preceding clause, wherein the one or more features comprise a dip, a closed dip, or both.

The system of any preceding clause, wherein the one or more parameters associated with the one or more features comprises an inclination, an azimuth, a phase, an amplitude, or a combination thereof.

The system of any preceding clause, wherein the processing circuitry performs the operations comprising receiving the prediction dataset, generating a detection loss term indicative of a loss of the one or more depths of the one or more features based on the prediction dataset and the synthetic dataset, generating a regression loss term indicative of a loss of the one or more parameters of the one or more features based on the prediction dataset and the synthetic dataset, and generating a loss function comprising the detection loss term the regression loss term, and a coefficient, wherein the coefficient is configured to scale between the detection loss term and the regression loss term.

The system of any preceding clause, wherein the processing circuitry performs the operations comprising outputting a confidence probability of the prediction dataset, based on quantitative analysis of the prediction dataset using the loss function, updating the feature detection model based on the confidence probability, and generating an updated feature detection model.

The system of any preceding clause, wherein the processing circuitry performs operations comprising reparametrizing the prediction dataset, reparametrizing the synthetic dataset, calculating one or more projection values associated with the reparametrized prediction dataset and the reparametrized synthetic dataset, normalizing the one or more projection values, generating one or more predicted projection values based on the one or more normalized projection values, wherein the one or more predicted projection values comprise one or more predicted depths, and generating one or more synthetic projection values based on the one or more predicted projection values, wherein the one or more predicted projection values correspond to one or more ground truth depths.

The system of any preceding clause, wherein determining if the one or more predicted projection values satisfies a threshold based on the one or more synthetic projection values, categorizing one or more feature predictions based on the threshold, wherein categorizing comprises determining if the one or more feature predictions is a false negative, a false positive, or a true positive, and calculating a precision, a recall, a F1 score, or a combination thereof of the feature detection model based on the categorization of the one or more feature predictions.

In certain embodiments, a method includes generating synthetic dataset representative of a plurality of synthetic borehole images and training a feature detection model based on the synthetic dataset, wherein the feature detection model is configured to predict one or more features associated with a plurality of borehole images at one or more depths, one or more parameters associated with the one or more features, or both. The method may also include generating a prediction dataset including a predicted detection vector and a predicted parameter matrix based on the feature detection model, wherein the predicted detection vector includes one or more indications of the one or more features at the one or more depths, and wherein the predicted parameter matrix includes the one or more parameters associated with the one or more features.

The method of the preceding clause, comprising receiving one or more constraints associated with the one or more parameters, sampling the one or more parameters randomly within the one or more constraints, and generating a parameter dataset based on the one or more sampled parameters.

The method of any preceding clause, comprising generating a content dataset based on the parameter dataset, wherein the content dataset comprises a plurality of un-stylized images, performing one or more style transfers on the content dataset, wherein the one or more style transfers comprise one or more neural style transfers, and generating the synthetic dataset based on the one or more styles transfers applied to the content data.

The method of any preceding clause, comprising inputting a detection probability threshold comprising a maximum probability along one or more scales at each depth of the one or more features and the one or more parameters, and training the feature detection model based on the detection probability threshold.

The method of any preceding clause, wherein the one or more features comprise a dip, a closed dip, or both, and wherein the one or more parameters associated with the one or more features comprises an inclination, an azimuth, a phase, an amplitude, or a combination thereof. rein

The method of any preceding clause, comprising reparametrizing the prediction dataset, reparametrizing the synthetic dataset, calculating one or more projection values associated with the reparametrized prediction dataset and the reparametrized synthetic dataset, normalizing the one or more projection values, generating one or more predicted projection values based on the one or more normalized projection values, wherein the one or more predicted projection values comprise one or more predicted depths, and generating one or more synthetic projection values based on the one or more predicted projection values, wherein the one or more predicted projection values correspond to one or more ground truth depths.

A non-transitory, computer-readable storage medium, comprising processor-executable routines that, when executed by a processor, cause the processor to perform operations includes generating synthetic dataset representative of a plurality of synthetic borehole images and training a feature detection model based on the synthetic dataset, wherein the feature detection model predicts one or more features associated with a plurality of borehole images at one or more depths, one or more parameters associated with the one or more features, or both. The operations may also include generating a prediction dataset comprising a predicted detection vector and a predicted parameter matrix based on the feature detection model, wherein the predicted detection vector includes one or more indications of the one or more features at the one or more depths, and wherein the predicted parameter matrices include the one or more parameters associated with the one or more features.

The non-transitory computer-readable storage medium of the preceding clause, wherein the processor performs operations comprising reparametrizing the prediction dataset, reparametrizing the synthetic dataset, calculating one or more projection values associated with the reparametrized prediction dataset and the reparametrized synthetic dataset, normalizing the one or more projection values, generating one or more predicted projection values based on the one or more normalized projection values, wherein the one or more predicted projection values comprise one or more predicted depths, and generating one or more synthetic projection values based on the one or more predicted projection values, wherein the one or more predicted projection values correspond to one or more ground truth depths.

The non-transitory computer-readable storage medium of any preceding clause, wherein the processor performs operations comprising inputting a detection probability threshold comprising a maximum probability along one or more scales at each depth of the one or more features and the one or more parameters and training the feature detection model based on the detection probability threshold.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principals of the disclosure and its practical applications, to thereby enable others skilled in the art to best utilize the disclosure and various embodiments with various modifications as are suited to the particular use contemplated.

Finally, the techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system, comprising:
a processing circuitry; and
a memory, accessible by the processing circuitry, the memory storing instructions that, when executed by the processing circuitry cause the processing circuitry to perform operations comprising:
generating synthetic dataset representative of a plurality of synthetic borehole images;
training a feature detection model based on the synthetic dataset, wherein the feature detection model is configured to predict one or more features associated with a plurality of borehole images at one or more depths, one or more parameters associated with the one or more features, or both; and
generating a prediction dataset comprising a predicted detection vector and a predicted parameter matrix based on the feature detection model, wherein the predicted detection vector comprises one or more indications of the one or more features at the one or more depths, and wherein the predicted parameter matrix comprises the one or more parameters associated with the one or more features.

2. The system of claim 1, wherein the processing circuitry performs the operations comprising:
receiving one or more constraints associated with the one or more parameters;
sampling the one or more parameters randomly within the one or more constraints; and
generating a parameter dataset based on the one or more sampled parameters.

3. The system of claim 2, wherein the processing circuitry performs the operations comprising:
generating a content dataset based on the parameter dataset, wherein the content dataset comprises a plurality of un-stylized images;
performing one or more style transfers on the content dataset, wherein the one or more style transfers comprise one or more neural style transfers; and
generating the synthetic dataset based on the one or more styles transfers applied to the content data.

4. The system of claim 1, wherein the processing circuitry performs the operations comprising:
receiving a real dataset comprising one or more additional parameters extracted from one or more additional borehole images associated with one or more real-world boreholes; and
training the feature detection model with the real dataset.

5. The system of claim 1, wherein the processing circuitry performs the operations comprising:
inputting a detection probability threshold comprising a maximum probability along one or more scales at each depth of the one or more features and the one or more parameters; and
training the feature detection model based on the detection probability threshold.

6. The system of claim 1, wherein the one or more features comprise a dip, a closed dip, or both.

7. The system of claim 1, wherein the one or more parameters associated with the one or more features comprises an inclination, an azimuth, a phase, an amplitude, or a combination thereof.

8. The system of claim 1, wherein the processing circuitry performs the operations comprising:
receiving the prediction dataset;
generating a detection loss term indicative of a loss of the one or more depths of the one or more features based on the prediction dataset and the synthetic dataset;
generating a regression loss term indicative of a loss of the one or more parameters of the one or more features based on the prediction dataset and the synthetic dataset; and
generating a loss function comprising the detection loss term the regression loss term, and a coefficient, wherein the coefficient is configured to scale between the detection loss term and the regression loss term.

9. The system of claim 8, wherein the processing circuitry performs the operations comprising:
outputting a confidence probability of the prediction dataset, based on quantitative analysis of the prediction dataset using the loss function;
updating the feature detection model based on the confidence probability; and
generating an updated feature detection model.

10. The system of claim 1, wherein the processing circuitry performs operations comprising:
reparametrizing the prediction dataset;
reparametrizing the synthetic dataset;
calculating one or more projection values associated with the reparametrized prediction dataset and the reparametrized synthetic dataset;
normalizing the one or more projection values;
generating one or more predicted projection values based on the one or more normalized projection values, wherein the one or more predicted projection values comprise one or more predicted depths; and
generating one or more synthetic projection values based on the one or more predicted projection values, wherein the one or more predicted projection values correspond to one or more ground truth depths.

11. The system of claim 10, wherein the processing circuitry performs operations comprising:
determining if the one or more predicted projection values satisfies a threshold based on the one or more synthetic projection values;
categorizing one or more feature predictions based on the threshold, wherein categorizing comprises determining if the one or more feature predictions is a false negative, a false positive, or a true positive; and
calculating a precision, a recall, a F1 score, or a combination thereof of the feature detection model based on the categorization of the one or more feature predictions.

12. A method comprising:
generating synthetic dataset representative of a plurality of synthetic borehole images;
training a feature detection model based on the synthetic dataset, wherein the feature detection model is configured to predict one or more features associated with a plurality of borehole images at one or more depths, one or more parameters associated with the one or more features, or both; and
generating a prediction dataset comprising a predicted detection vector and a predicted parameter matrix based on the feature detection model, wherein the predicted detection vector comprises one or more indications of the one or more features at the one or more depths, and wherein the predicted parameter matrix comprises the one or more parameters associated with the one or more features.

13. The method of claim 12 comprising:
receiving one or more constraints associated with the one or more parameters;
sampling the one or more parameters randomly within the one or more constraints; and
generating a parameter dataset based on the one or more sampled parameters.

14. The method of claim 12, comprising:
generating a content dataset based on the parameter dataset, wherein the content dataset comprises a plurality of un-stylized images;
performing one or more style transfers on the content dataset, wherein the one or more style transfers comprise one or more neural style transfers; and
generating the synthetic dataset based on the one or more styles transfers applied to the content data.

15. The method of claim 12, comprising:
inputting a detection probability threshold comprising a maximum probability along one or more scales at each depth of the one or more features and the one or more parameters; and
training the feature detection model based on the detection probability threshold.

16. The method of claim 12, wherein the one or more features comprise a dip, a closed dip, or both, and wherein the one or more parameters associated with the one or more features comprises an inclination, an azimuth, a phase, an amplitude, or a combination thereof.

17. The method of claim 12, comprising:
reparametrizing the prediction dataset;
reparametrizing the synthetic dataset;
calculating one or more projection values associated with the reparametrized prediction dataset and the reparametrized synthetic dataset;
normalizing the one or more projection values;
generating one or more predicted projection values based on the one or more normalized projection values, wherein the one or more predicted projection values comprise one or more predicted depths; and
generating one or more synthetic projection values based on the one or more predicted projection values, wherein the one or more predicted projection values correspond to one or more ground truth depths.

18. A non-transitory, computer-readable storage medium, comprising processor-executable routines that, when executed by a processor, cause the processor to perform operations comprising:
generating synthetic dataset representative of a plurality of synthetic borehole images;
training a feature detection model based on the synthetic dataset, wherein the feature detection model is configured to predict one or more features associated with a plurality of borehole images at one or more depths, one or more parameters associated with the one or more features, or both; and
generating a prediction dataset comprising a predicted detection vector and a predicted parameter matrix based on the feature detection model, wherein the predicted detection vector comprises one or more indications of the one or more features at the one or more depths, and wherein the predicted parameter matrix comprise the one or more parameters associated with the one or more features.

19. The non-transitory computer-readable storage medium of claim 18, wherein the processor performs operations comprising:
reparametrizing the prediction dataset;
reparametrizing the synthetic dataset;
calculating one or more projection values associated with the reparametrized prediction dataset and the reparametrized synthetic dataset;
normalizing the one or more projection values;
generating one or more predicted projection values based on the one or more normalized projection values, wherein the one or more predicted projection values comprise one or more predicted depths; and
generating one or more synthetic projection values based on the one or more predicted projection values, wherein the one or more predicted projection values correspond to one or more ground truth depths.

20. The non-transitory computer-readable storage medium of claim 18, wherein the processor performs operations comprising:
inputting a detection probability threshold comprising a maximum probability along one or more scales at each depth of the one or more features and the one or more parameters; and
training the feature detection model based on the detection probability threshold.
